(19) United States
(12) Patent Application Publication
(10) Pub. No.: US 2019/0198911 A1
(43) Pub. Date: Jun. 27, 2019

(54) LITHIUM SECONDARY BATTERY

(71) Applicants: Samsung Electronics Co., Ltd., Suwon-si (KR); Samsung SDI Co., Ltd., Yongin-si (KR)

(72) Inventors: Jirae Kim, Seoul (KR); Hyorang Kang, Anyang-si (KR); Soyeon Kim, Suwon-si (KR); Dongmin Im, Seoul, (KR); Wonseok Chang, Seoul (KR)

(21) Appl. No.: 16/030,120

(22) Filed: Jul. 9, 2018

(30) Foreign Application Priority Data
Dec. 27, 2017 (KR) 10-2017-0180037

(51) Int. Cl. H01M 10/04; H01M 10/0525; H01M 2/02

(52) U.S. Cl. CPC H01M 10/0468; H01M 2/0257; H01M 10/0525

(57) ABSTRACT

A lithium secondary battery includes: a lithium secondary cell including a surface parallel to an electrode surface, a single-body pressing structure configured to apply pressure to the surface of the lithium secondary cell, wherein the pressing structure is configured to contract and expand in response to a change of volume of the lithium secondary cell; and a housing that accommodates the lithium secondary cell and the pressing structure, wherein an area of a surface of the lithium secondary battery which is parallel to the electrode surface is less than an area of a surface of the lithium secondary battery which is orthogonal to the electrode surface.

### CROSS-REFERENCE TO RELATED APPLICATION

This application claims priority to and the benefit of Korean Patent Application No. 10-2017-0180037, filed on Dec. 26, 2017, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a lithium secondary battery, and more particularly, to a lithium secondary battery wherein a thickness change due to lithium may be reduced during charge or discharge.

### 2. Description of the Related Art

Secondary batteries, which are rechargeable, unlike primary batteries which cannot be recharged, are widely used for various electronic devices such as cellular phones, notebook computers, and camcorders. Particularly, lithium secondary batteries provide a higher voltage and have a higher energy density per unit weight than nickel-cadmium batteries and nickel-hydrogen batteries, and thus, a demand therefor is increasing.

During charge of a lithium secondary battery, lithium at a cathode moves to an anode and thus lithium metal is generated at the anode, thereby increasing the thickness of the anode. On the contrary, during discharge, lithium leaves the anode, and thus, the thickness of the anode decreases. To increase an electrodeposition density of lithium and the charging and discharging efficiency of the lithium secondary battery, it would be desirable to reduce the thickness change of the anode during charge and discharge of the battery.

### SUMMARY

Provided is a lithium secondary battery of which an electrodeposition density of lithium and charging and discharging efficiency may be increased by reducing a thickness change due to lithium during charge and discharge.

Additional aspects will be set forth in part in the description which follows and, in part, will be apparent from the description, or may be learned by practice of the presented embodiments.

According to an aspect of an embodiment, a lithium secondary battery includes: a lithium secondary cell including a surface parallel to an electrode surface; a single-body pressing structure configured to apply pressure to the surface of the lithium secondary cell, wherein the pressing structure is configured to contract and expand in response to a change of volume of the lithium secondary cell; and a housing that accommodates the lithium secondary cell and the pressing structure, wherein an area of a surface of the lithium secondary battery which is parallel to the electrode surface is less than an area of a surface of the lithium secondary battery which is orthogonal to the electrode surface.

The pressing structure may include a pressure jig and a case encapsulating the pressure jig, and a side surface of the case along a contracting-expanding direction may have a modulated shape to permit the pressing structure to contract or expand in response to a change of volume of the lithium secondary cell.

The pressure jig may include a spring, an elastic alloy, a flexible polymer, or a combination thereof.

The pressure jig may include a spring that generates an elastic force in the contracting-expanding direction.

The pressure jig may include a metal sheet having a convex shape in the contracting-expanding direction, and an end of the metal sheet may be fixed to the case.

Two metal sheets may be fixed to the case such that convex parts of the two metal sheets face each other.

The metal sheet may be fixed to the case.

The case may include a metal, a polymeric material, or a combination thereof, which does not corrode when in contact with an electrolyte solution.

The pressing structure may be disposed at an upper side, a lower side, or a middle of the lithium secondary battery, and the upper side, the lower side, and the middle may be in a direction orthogonal to the electrode surface of the lithium secondary cell.

The pressing structure may be sealed.

The contracting-expanding direction may be orthogonal to the surface of the lithium secondary cell.

The modulated shape may include a pleated shape to permit the pressing structure to contract or expand in response to a change of volume of the lithium secondary cell.

The modulated shape may include a sliding shape to permit the pressing structure to contract or expand in response to a change of volume of the lithium secondary cell.

The lithium secondary battery may include a plurality of lithium secondary cells.

The pressing structure may be between lithium secondary cells in a direction orthogonal to the surface of the lithium secondary cell.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of an embodiment of a lithium secondary battery;

FIG. 2 is a front view of an embodiment of the lithium secondary battery of FIG. 1 illustrating an internal structure thereof;

FIG. 3 is a front view of an embodiment of the lithium secondary battery of FIG. 2 illustrating operating states during charge and discharge thereof,;

FIGS. 4 and 5 are front views of an embodiment of a case of a pressing structure;

FIGS. 6 to 10 are front views of embodiments of a pressure jig of the pressing structure;

FIGS. 11 to 14 are front views various configurations of the pressing structure;

FIG. 15 is a graph illustrating electrodeposition density of lithium (grams per cubic centimeter (g/cc)) and a life span (cycles) versus applied pressure (atmospheres (atm)) in a pressing condition of the lithium secondary battery, according to an embodiment; and

FIG. 16 is a perspective view of an example of a lithium secondary battery.

### DETAILED DESCRIPTION

Reference will now be made in detail to embodiments, examples of which are illustrated in the accompanying drawings, wherein like reference numerals refer to like elements throughout, and the thickness or size of each component may be exaggerated for convenience of description. In this regard, the present embodiments may have different forms and should not be construed as being limited to the descriptions set forth herein. Accordingly, the embodiments are merely described below, by referring to the figures, to explain aspects. As used herein, expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A “cell” refers to a single electrochemical cell.

A “battery” refers to one or more cells, wherein a plurality of cells may be connected in series, parallel, or a combination thereof.

To increase an electrodeposition density of lithium and the charging and discharging efficiency of the lithium secondary battery, the thickness change due to lithium during charge and discharge of the battery is desirably reduced.

Hereinafter, a lithium secondary battery according to embodiments will be described in further detail with reference to the accompanying drawings.

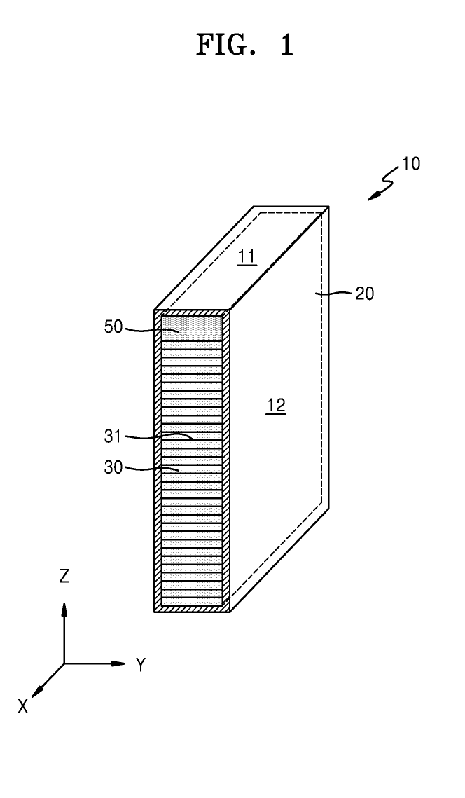

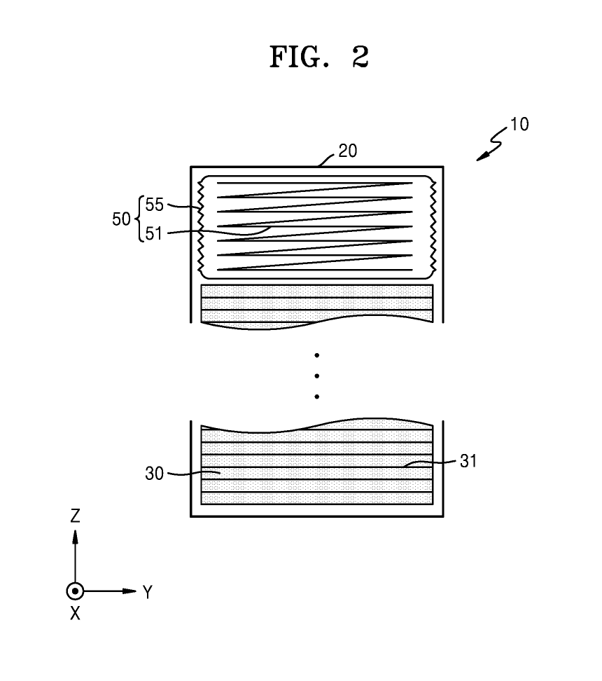

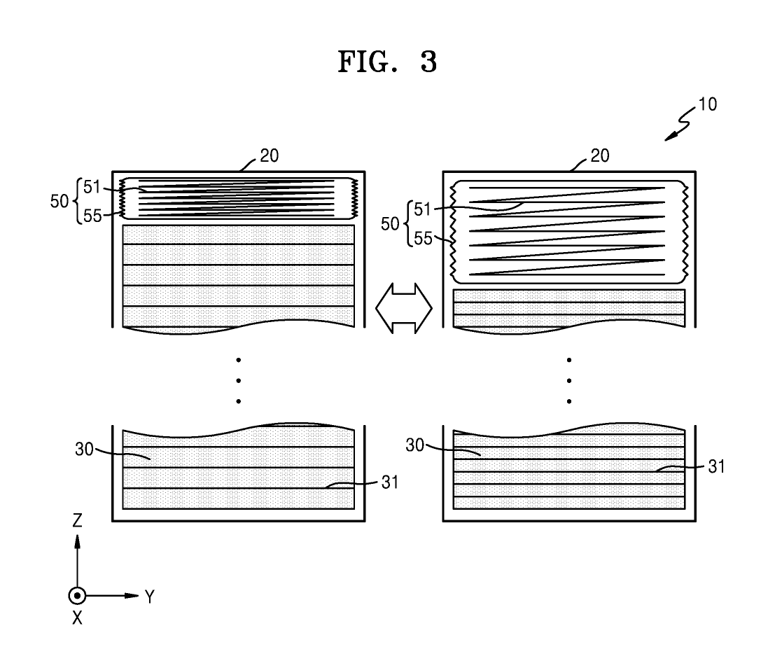

FIG. 1 is a perspective view of a lithium secondary battery 10 according to an embodiment. FIG. 2 is a front view of the lithium secondary battery 10 of FIG. 1 illustrating an internal structure thereof, according to an embodiment. FIG. 3 is a front view of the lithium secondary battery 10 of FIG. 2 illustrating operating states during charge and discharge thereof, according to an embodiment.

Referring to FIGS. 1 and 2, the lithium secondary battery 10 according to an embodiment includes a lithium secondary cell 30, a single-body pressing structure 50, and a housing 20 that accommodates the lithium secondary cell 30 and the single-body pressing structure 50.

According to an embodiment, the lithium secondary battery cell 30 may have a narrow and long shape in which an area of a first surface 11 of the lithium secondary battery 10 which is parallel to an electrode surface 31 is less than an area of a second surface 12 of the lithium secondary battery 10 which is orthogonal to the electrode surface 31.

In an embodiment, referring to FIG. 1, when the electrode surface 31 of the lithium secondary cell 30 is parallel to an x-y plane, the lithium secondary battery 10 may have a narrow and long shape in which an area of a surface 11 of the lithium secondary battery 10 parallel to the x-y plane is less than an area of a surface 12 of the lithium secondary battery 10 parallel to an x-z plane.

The lithium secondary cell 30 may have a structure in which a plurality of unit cells are stacked, the unit cell including an anode layer, a separator, and a cathode layer. An electrolyte may be provided, e.g., filled, between the cathode layer and the anode layer. The electrode surface 31 may be a surface of at least any one of the anode layer and the cathode layer, or may be a surface parallel to a surface of the cathode layer and the anode layer of the unit cell, which includes the anode layer, the separator, and the cathode layer.

The cathode layer may include a cathode active material. For example, the cathode active material may include a lithium (Li)-containing oxide. The Li-containing oxide may be an oxide containing Li and a transition metal. The Li-containing oxide may be, according to an embodiment, LiMO₂, wherein M denotes a metal, for example, cobalt (Co), nickel (Ni), manganese (Mn), or a combination thereof. For example, the Li-containing oxide may be LiCoO₂. The cathode active material may include ceramic and may have, a polycrystalline or a single crystalline structure. However, the detailed materials for the cathode active material described above are only illustrative, and other cathode active materials may be used.

The anode layer may include lithium metal. A lithium metal thin film may be used for the anode layer including lithium metal. As another example, the anode layer including a lithium metal may include a current collector and an anode active material layer disposed on the current collector. In this case, the anode active material layer may include, for example, a metal, a transition metal oxide, a non-transition metal oxide, a carbon-based material, a silicon-based material, or the like which is alloyable with lithium, or a combination thereof. Lithium metal is mentioned. Herein, detailed materials for an anode active material are not limited thereto.

The separator is inserted between the anode layer and the cathode layer and may be an insulating thin film having a high ion transmittance and a high mechanical strength. The separator may be, for example, a sheet or non-woven fabric made of an olefin-group-containing polymer such as polypropylene, a glass fiber, polyethylene, or the like. The separator may comprise, for example, polyethylene, polypropylene, polyvinylidene fluoride, or a combination thereof, and may be in the form of a multi-layer film thereof (two or more layers). When a solid polymer electrolyte is used for the electrolyte, the solid polymer electrolyte may also be used for the separator.

An electrolyte solution may be filled between the anode layer and the cathode layer of the lithium secondary cell 30. The electrolyte solution may include a liquid electrolyte, a solid electrolyte, or a combination thereof. The liquid electrolyte may comprise a suitable salt and solvent. The lithium salt may be, for example, LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, Li N(SO₂CF₃)₂, LiN(SO₂F)₂, LiSbF₆, LiPF₃(CF₂CF₃)₃, LiPF₃(CF₃)₃, LiB(C₂O₄)₂, or a combination thereof. An amount of the lithium salt may be about 0.5 molar (M) to about 2M. The solvent may be a carbonate-based solvent, such as ethylene carbonate, propylene carbonate, dimethyl carbonate, diethyl carbonate, ethyl methyl carbonate, or a combination thereof. The electrolyte solution may include a solid electrolyte such as Li₃PO₄, Li₃PO₄₋ₓNₓ, LiBO₂₋ₓNₓ, Li₃PO₄Nₓ, LiBO₂Nx, Li₄SiO₄—Li₃PO₄, Li₄SiO₄—Li₃VO₄, or Li₇La₃Zr₂O₁₂ (“LLZO”). The electrolyte solution may include a solid polymer electrolyte. Materials for the electrolyte solution may be variously changed.

In the lithium secondary battery 10 according to an embodiment, a plurality of lithium secondary cells 30 may be stacked such that an area of a surface 11 of the lithium secondary battery 10 parallel to the electrode surface 31 is less than an area of a surface 12 of the lithium secondary battery 10 orthogonal to the electrode surface 31.

The lithium secondary battery 10 may comprise any suitable number of lithium secondary cells 30. A quantity of lithium secondary cells 30 may be 2 to 100,000, for example, 10 to 80,000, 20 to 70,000, 30 to 60,000, or 40 to 50,000, or 5 to 1000, 7 to 500, or 10 to 250. The lithium secondary cells 30 may be stacked such that the area of a surface 11 of the lithium secondary battery 10 parallel to the electrode surface 31 is less than the area of a surface 12 of the lithium secondary battery 10 orthogonal to the electrode surface 31.

In the lithium secondary battery 10, during charge, lithium ions in the cathode layer move to the anode layer, thereby increasing the thickness of the anode layer, and on the contrary, during discharge, lithium ions move from the anode layer to the cathode layer, thereby decreasing the thickness of the anode layer.

During such charging and discharging of the lithium secondary battery 10, it would be desirable to increase an electrodeposition density of lithium by applying pressure to the lithium secondary cell 30 to minimize a thickness change of the lithium secondary cell 30.

The pressing structure 50 may reduce a thickness change during charge and discharge by pressing the lithium secondary cell 30 on a surface parallel to the electrode surface 31 of the lithium secondary cell 30.

The pressing structure 50 may have an effective, e.g., actual pressing, area corresponding to the electrode surface 31 and may be provided so as to contract or expand according to a relative pressing force applied to the lithium secondary cell 30. Herein, the effective, e.g., actual pressing, area of the pressing structure 50 may be less than or greater than the area of the electrode surface 31. As used herein, “pressing force” or “relative pressing force” refers to a positive or negative, e.g., increase or decrease of, pressure applied, e.g., to a lithium secondary cell 30.

As shown in FIGS. 1 and 2, when the electrode surface 31 of the lithium secondary cell 30 is parallel to the x-y plane, a contracting-expanding direction of the pressing structure 50 may be a direction along the z axis.

Referring to FIG. 2, for example, the pressing structure 50 may be a single body structure including a pressure jig 51 and a case 55 encapsulating the pressure jig 51 and may be provided so as to contract or expand according to a relative pressing force applied to the lithium secondary cell 30.

The pressing structure 50 may be sealed so as not to come in contact with the electrolyte solution and the like of the lithium secondary cell 30, and to this end, the case 55 of the pressing structure 50 may be formed of a metal, a polymeric material, or a combination thereof, which is not corroded when in contact with the electrolyte solution of the lithium secondary cell 30.

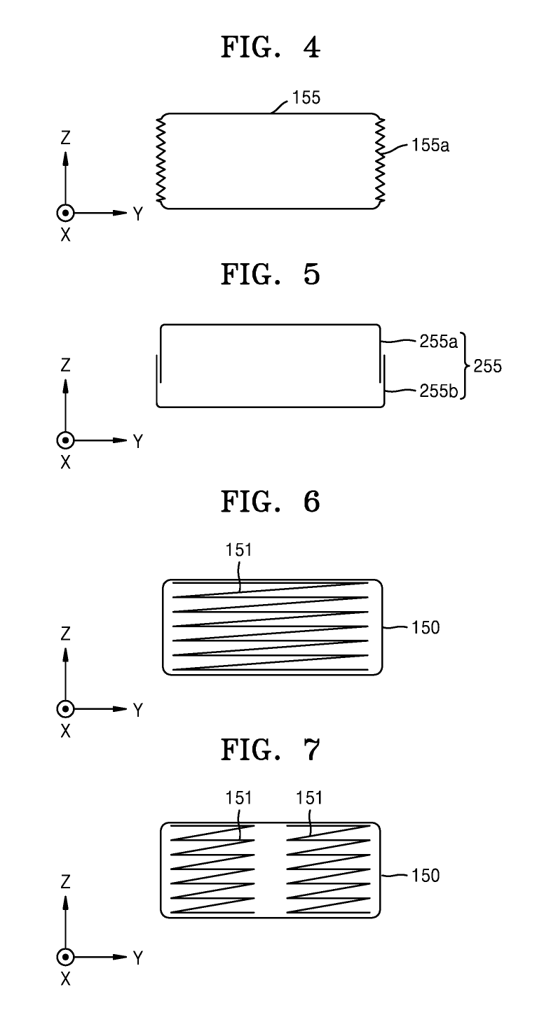

To enable the pressing structure 50 to contract or expand, side surfaces of the case 55 along the contracting-expanding direction may be formed to have a modulated shape such as pleated shape as shown in FIG. 4, or a sliding shape as shown in FIG. 5. Referring to FIG. 4, when a side surface 155a of a case 155 along the contracting-expanding direction is formed in a pleated manner, pleats are further folded as the pressure jig 51 relatively contracts according to a relative pressing force applied to the lithium secondary cell 30, and the pleats are further unfolded as the pressure jig 51 relatively relaxes, e.g., decreases an amount of pressure being applied to the lithium secondary cell 30. Referring to FIG. 5, when a case 255 has a sliding shape in which the pressing structure 50 contracts or expands, an upper case 255a and a lower case 255b are sliding-coupled such that the pressing structure 50 contracts or expands according to a relative pressing force applied to the lithium secondary battery cell 30.

The pressure jig 51 may include at least one of a spring, an elastic alloy, and a flexible polymer.

For example, the pressure jig 51 may include at least one spring 151 disposed so as to have an elastic force in the contracting-expanding direction as shown in FIGS. 6 and 7. FIG. 6 shows an example in which the pressure jig 51 includes a single spring 151. FIG. 7 shows an example in which the pressure jig 51 includes two springs 151. The number of springs 151 applied as the pressure jig 51 is not limited to FIGS. 6 and 7, and various numbers of springs 151 may be applied. Reference numeral 150 in FIGS. 6 and 7 indicates a case.

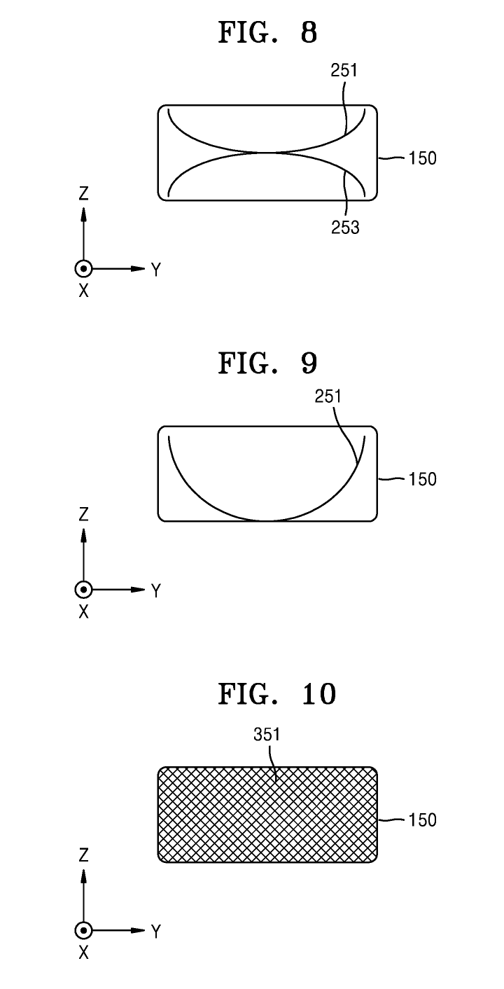

As other examples, the pressure jig 51 may include at least one metal sheet 251 and 253 of a convex shape in a direction along or in the contracting-expanding direction as shown in FIGS. 8 and 9, and an end of the at least one metal sheet 251 and 253 may be fixed to an upper part or a lower part of the case 150 along or in the contracting-expanding direction of the case 150. FIG. 8 shows an example in which two metal sheets 251 and 253 are fixed to the case 150 such that convex parts of the two metal sheets 251 and 253 face each other. FIG. 9 shows an example in which a metal sheet 251 is fixed to the case 150.

As shown in FIG. 8, when the two metal sheets 251 and 253 are fixed to the case 150 such that convex parts of the two metal sheets 251 and 253 face each other, the two metal sheets 251 and 253 may be installed in a structure in which an end of the metal sheet 251 located at an upper side in the contracting-expanding direction is fixed to the upper part of the case 150, an end of the metal sheet 253 located at a lower side is fixed to the lower part of the case 150, and the convex parts of the two metal sheets 251 and 253 meet, e.g., contact, each other such that a force of pressing the lithium secondary cell 30 is applied to the lithium secondary cell 30.

As shown in FIG. 9, when the a metal sheet 251 is fixed to the case 150, the metal sheet 251 may be installed in a structure in which an end of the metal sheet 251 is fixed to any one of the upper and lower parts of the case 150, and a convex part of the metal sheet 251 meets, e.g., contacts, the other one of the upper and lower parts of the case 150 such that a force of pressing the lithium secondary cell 30 is applied to the lithium secondary cell 30. FIG. 9 shows an example in which the metal sheet 251 is mounted in the case 150 such that the convex part faces the lithium secondary battery cell 30.

As another example, the pressure jig 51 may be formed of a flexible polymer 351 having a mesh form as shown in FIG. 10.

Although only the case 150 in which the pressure jig 51 is sealed is shown in FIGS. 6 to 10, the case 150 in FIGS. 6 to 10 may be the case 155 of which the side surfaces of the pressing structure 50 along the contracting-expanding direction are formed in a pleated manner as shown in FIG. 4 or the case 255 of a sliding manner as shown in FIG. 5. For convenience of drawing, FIGS. 6 to 10 show only the case 150.

Although FIGS. 2 and 3 show a case in which the side surfaces of the case 55 of the pressing structure 50 are formed in a pleated manner, and the pressure jig 51 includes an elastic spring, this case is illustrative. The pressing structure 50 in FIGS. 2 and 3 may include the sliding case 255 as shown in FIG. 5 instead of the case 155 having pleated side surfaces as shown in FIG. 4. In addition, the pressing structure 50 in FIGS. 2 and 3 may include the pressure jig 51 in various shapes as shown in FIGS. 6 to 10. In addition, the case 55 and the pressure jig 51 of the pressing structure 50 are not limited to the configurations shown in FIGS. 4 to 10 and may have various shapes so as to contract or expand according to a relative pressing force applied to the lithium secondary cell 30.

Although FIGS. 1 to 3 show a case in which the pressing structure 50 presses the lithium secondary battery cell 30 from an upper side, the pressing structure 50 may be disposed in various ways.

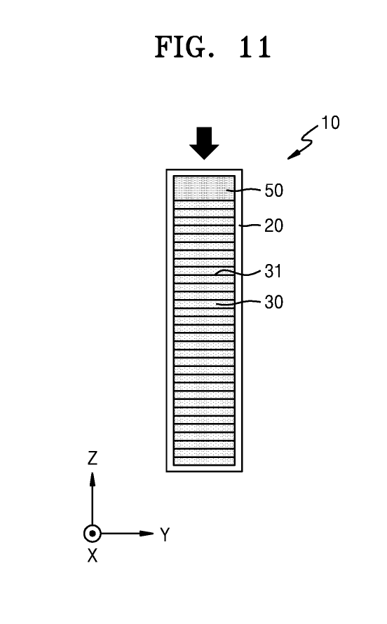

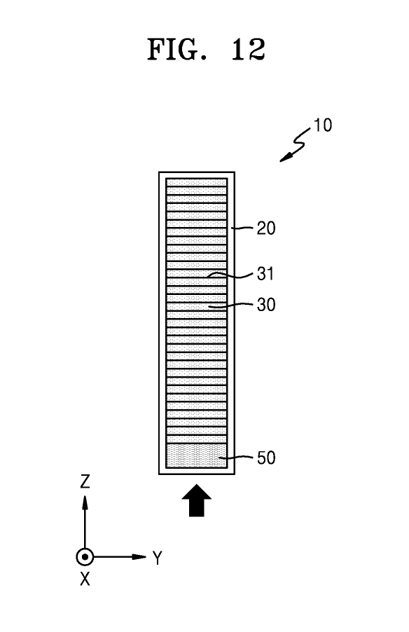

For example, the pressing structure 50 may be disposed so as to press the lithium secondary battery cell 30 from a lower side as shown in FIG. 12 instead of pressing the lithium secondary cell 30 from an upper side as shown in FIG. 11.

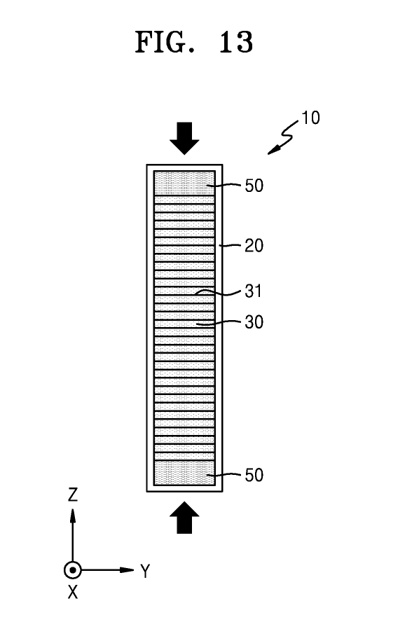

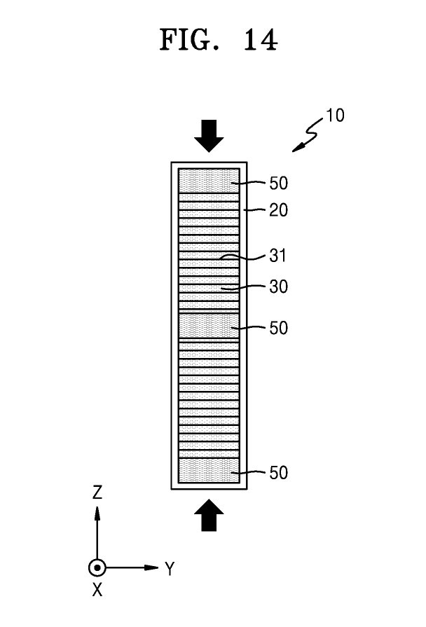

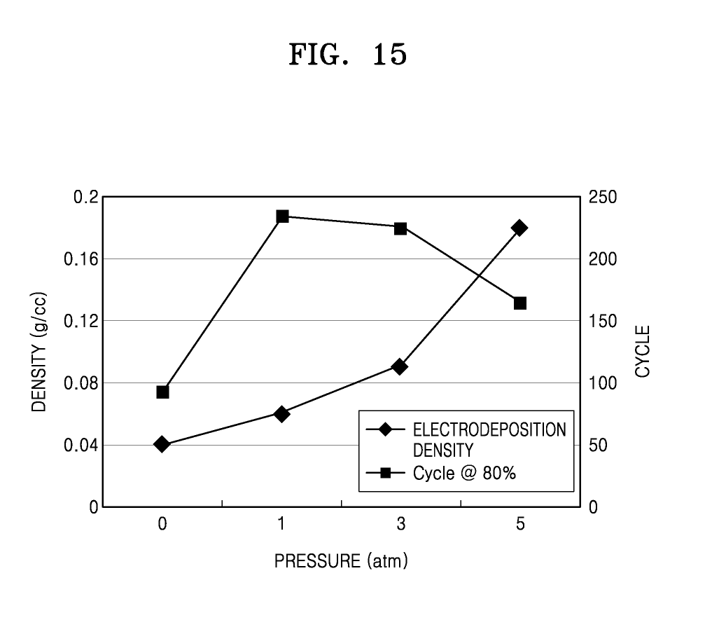

Alternatively, the pressing structure 50 may be provided so as to press the lithium secondary cell 30 from a lower side and an upper side as shown in FIG. 13. Alternatively, the pressing structure 50 may be provided so as to also press the lithium secondary cell 30 in the middle of the lithium secondary battery cell 30 as shown in FIG. 14. FIG. 14 shows a case in which the pressing structure 50 presses the lithium secondary battery cell 30 in the middle and also from an upper side and a lower side, but the pressing structure 50 may be provided so as to press the lithium secondary cell 30 only in the middle of the lithium secondary battery cell 30, or provided so as to press the lithium secondary battery cell 30 from any one of an upper side and a lower side and in the middle of the lithium secondary cell 30.

As is further described above, in the lithium secondary battery 10 according to an embodiment, the pressing structure 50 may be located at an upper side, at a lower side, at both sides, in the middle, or the like to act as a buffer in response to a volume change of the lithium secondary cell 30 during charge and discharge and to increase an electrodeposition density of lithium during charge by pressing the lithium secondary cell 30.

In the lithium secondary battery 10 according to an embodiment, the pressing structure 50 presses the lithium secondary cell 30 in a small area, and thus the pressing structure 50 may be formed so as to occupy a relatively small volume, e.g., of several %, for example, about 4.5%, of a total volume of the lithium secondary battery 10. In an embodiment, the pressing structure 50 occupies about 1% to about 20%, about 2% to about 16%, or about 4% to about 8% of a total volume of the lithium secondary battery 10. In addition, for example, when the cathode layer is about 65 micrometers (pm) thick, the anode layer may be about 50 μm thick, the separator may be about 30 μm thick, the solid electrolyte may be about 150 μm thick, and the current collector may be about 30 μm thick, a unit cell of the lithium secondary battery cell 30 may have a thickness of 325 μm, and thus an increasing thickness during charge may be about 15 μm.

According to the lithium secondary battery 10 according to an embodiment, as shown in the left image of FIG. 3, during charge, the pressing structure 50 contracts due to volume expansion of the anode layer, and pressure due to the contraction may suppress the growth of dendrites. As shown in the right image of FIG. 3, during discharge, the pressing structure 50 expands so as to return to an original structure.

Therefore, according to the lithium secondary battery 10 according to an embodiment, since constant pressure is applied to the lithium secondary cell 30 by means of the pressing structure 50, a thickness change due to lithium may be minimized during charge and discharge, and a lithium electrodeposition density may be increased, and thus charging and discharging efficiency may be increased.

That is, according to the lithium secondary battery 10 according to an embodiment, since constant pressure may be applied to the lithium secondary cell 30 in both a state in which a volume of the lithium secondary cell 30 expands, e.g., increases, during charge and a state in which a volume of the lithium secondary cell 30 contracts, e.g., decreases, during discharge, a lithium electrodeposition density during charge may be increased, and lithium ions move to the cathode layer during discharge, and thus charging and discharging efficiency may be increased.

FIG. 15 is a graph illustrating characteristics of a lithium secondary battery 10 depending on a pressing condition of the lithium secondary battery 10, according to an embodiment, and shows an electrodeposition density of lithium (g/cc) and a life span (cycles, tested at 80% depth of discharge) of the lithium secondary cell 30 according to applied pressure (atm).

As shown in FIG. 15, according to the lithium secondary battery 10 according to an embodiment, as pressure applied to the pressing structure 50 increases, an electrodeposition density increases. In addition, the lithium secondary cell 30 has an improved life span when pressure applied to the pressing structure 50 is in a range of about 1 to about 3 atmospheres (atm). Herein, characteristics of the lithium secondary battery 10 according to a pressing condition is illustrative, and the present embodiment is not limited thereto, and the characteristics of the lithium secondary battery 10 may vary.

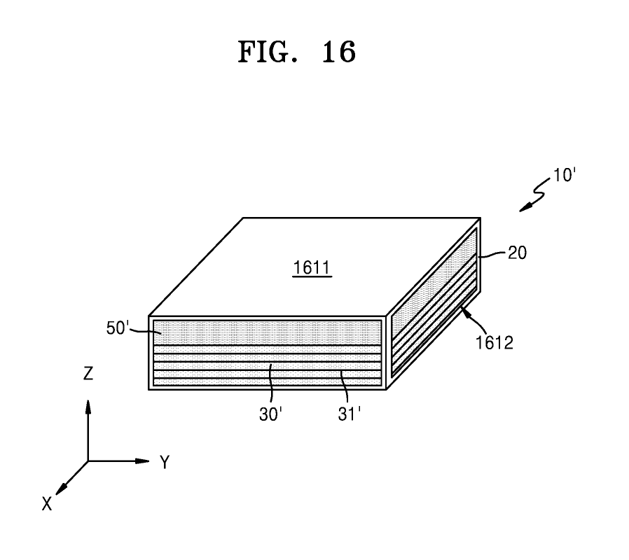

FIG. 16 shows, as a comparative example, a case in which, unlike the lithium secondary battery 10 according to an embodiment, a lithium secondary battery 10′ has a structure in which an area of a surface 1611 parallel to an electrode surface 31′ of a lithium secondary cell 30′, e.g., parallel to an x-y plane, is greater than an area of a surface 1612 orthogonal to the electrode surface 31′ and is formed in a cell stacking manner in which cells are stacked by using a wide surface as a bottom.

Like the lithium secondary battery 10 according to an embodiment, the lithium secondary battery 10′ of the comparative example may include the lithium secondary cell 30′, a single-body pressing structure 50′, and a housing 20′ that accommodates the lithium secondary cell 30′ and the single-body pressing structure 50′.

When the lithium secondary battery 10 according to the embodiment of FIG. 1 is compared with the lithium secondary battery 10′ of the comparative example of FIG. 16, by modifying a wide x-y plane shape to be narrow, a surface to which pressure is applied is relatively smaller such that uniform pressure may be applied to the entire surface, and an area occupied by the pressing structure 50 may be reduced such that an energy density of the lithium secondary battery 10 may be improved relative to lithium secondary battery 10′.

That is, compared with the lithium secondary battery 10′ of the comparative example , in the lithium secondary battery 10 according to an embodiment, by applying pressure to a narrower surface to press a cell at higher pressure, a density of lithium electrodeposited on an anode layer may be increased, and a uniform surface state and pressure distribution may be maintained over the entire surface of an electrode layer, and thus cell charging and discharging efficiency may be increased, and even when a solid electrolyte is used, the lithium electrodeposition density may be increased.

In addition, compared with the lithium secondary battery 10′ of the comparative example, the lithium secondary battery 10 according to an embodiment has a smaller volume which the pressing structure 50 occupies, and thus the lithium secondary battery 10 may be improved relative to the lithium secondary battery 10′, for example, an energy density of the lithium secondary battery 10 may be improved relative to lithium secondary battery 10′.

According to a lithium secondary battery of the present disclosure, since a constant pressure may be applied to a lithium secondary cell by a pressing structure in both a state in which a volume of the lithium secondary cell expands during charge of the lithium secondary battery and a state in which a volume of the lithium secondary battery cell contracts during discharge of the lithium secondary battery, a thickness change due to lithium may be minimized during charge and discharge of the lithium secondary battery and a lithium electrodeposition density during charge may be increased. Thus, charging and discharging efficiency of the lithium secondary battery may be increased.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium secondary battery comprising:
a lithium secondary cell comprising a surface parallel to an electrode surface;
a single-body pressing structure configured to apply pressure to the surface of the lithium secondary cell, wherein the pressing structure is configured to contract and expand in response to a change of volume of the lithium secondary cell; and
a housing that accommodates the lithium secondary cell and the pressing structure,
wherein an area of a surface of the lithium secondary battery which is parallel to the electrode surface is less than an area of a surface of the lithium secondary battery which is orthogonal to the electrode surface.

2. The lithium secondary battery of claim 1, wherein
the pressing structure comprises a pressure jig and a case encapsulating the pressure jig, and
a side surface of the case along a contracting-expanding direction has a modulated shape to permit the pressing structure to contract or expand in response to a change of volume of the lithium secondary cell.

3. The lithium secondary battery of claim 2, wherein the pressure jig comprises a spring, an elastic alloy, a flexible polymer, or a combination thereof.

4. The lithium secondary battery of claim 2, wherein the pressure jig comprises a spring that generates an elastic force in the contracting-expanding direction.

5. The lithium secondary battery of claim 2, wherein the pressure jig comprises a metal sheet having a convex shape in the contracting-expanding direction, and wherein an end of the metal sheet is fixed to the case.

6. The lithium secondary battery of claim 5, wherein two metal sheets are fixed to the case such that convex parts of the two metal sheets face each other.

7. The lithium secondary battery of claim 5, wherein the metal sheet is fixed to the case.

8. The lithium secondary battery of claim 2, wherein the case comprises a metal, a polymeric material, or a combination thereof, which does not corrode when in contact with an electrolyte solution.

9. The lithium secondary battery of claim 2, wherein the pressing structure is disposed at an upper side, a lower side, or a middle of the lithium secondary battery, and wherein the upper side, the lower side, and the middle are in a direction orthogonal to the electrode surface of the lithium secondary cell.

10. The lithium secondary battery of claim 9, wherein the pressing structure is sealed.

11. The lithium secondary battery of claim 1, wherein the pressing structure is disposed at an upper side, a lower side, or a middle of the lithium secondary battery, wherein the upper side, the lower side, and the middle are in a direction orthogonal to the electrode surface of the lithium secondary battery cell.

12. The lithium secondary battery of claim 11, wherein the pressing structure is sealed.

13. The lithium secondary battery of claim 2, wherein the contracting-expanding direction is orthogonal to the surface of the lithium secondary cell.

14. The lithium secondary battery of claim 2, wherein the modulated shape comprises a pleated shape to permit the pressing structure to contract or expand in response to a change of volume of the lithium secondary cell.

15. The lithium secondary battery of claim 2, wherein the modulated shape comprises a sliding shape to permit the pressing structure to contract or expand in response to a change of volume of the lithium secondary cell.

16. The lithium secondary battery of claim 2, wherein the lithium secondary lo battery comprises a plurality of lithium secondary cells.

17. The lithium secondary battery of claim 16, wherein the pressing structure is between lithium secondary cells in a direction orthogonal to the surface of the lithium secondary cell.

18. The lithium secondary battery of claim 1, wherein the lithium secondary battery comprises a plurality of lithium secondary cells.

19. The lithium secondary battery of claim 18, wherein the pressing structure is between lithium secondary cells in a direction orthogonal to the surface of the lithium secondary cell.
